(19) United States
(12) Patent Application Publication
(10) Pub. No.: US 2008/0200125 A1
(43) Pub. Date: Aug. 21, 2008

(54) Radio Broadcasting Device

(75) Inventors: Richard John Caldwell, Reigate (GB); Adrian Weston Payne, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,829

(22) PCT Filed: Aug. 24, 2006
(86) PCT No.: PCT/IB2006/052940

§ 371 Date: Feb. 26, 2008

(30) Foreign Application Priority Data
Sep. 2, 2005 (EP) 05108041.4

(51) Int. Cl. H04B 1/00

(52) U.S. Cl. 455/42

(57) ABSTRACT

The invention relates to a radio broadcasting device for transmitting data from a portable entertainment device, such as a CD player, cassette player or MP3 player, to a neighboring radio receiver, for example in a car audio system. The radio broadcasting device is adapted to transmit data at a first frequency; transmit, at the first frequency, information identifying an alternative frequency on which to transmit the data; and switch the transmission of the data to the alternative frequency.

The invention relates generally to a radio broadcasting device, and in particular relates to a radio broadcasting device for transmitting data from a portable entertainment device to a radio receiver.

It is often desirable for a user of a portable entertainment device, for example a CD player, audio cassette player, MP3 player or mobile telephone, to listen to the music or other audio stored in the portable entertainment device whilst the user is traveling in a vehicle.

One conventional way of allowing this is to directly connect the portable entertainment device to the vehicle audio system, for example by connecting the entertainment device to a cradle that is wired into the vehicle audio system.

An alternative way of allowing this is to provide some means, either integral with the portable entertainment device or as a separate attachment for the device, which broadcasts the audio information at a selected radio frequency over a small area. The radio of the vehicle audio system can be tuned to the selected frequency, allowing the user to listen to the music or other audio without requiring any direct connection between the portable entertainment device and vehicle audio system. In many known devices, the FM frequency band is used for this transmission.

However, the frequency band available for these transmissions has a limited width, and is often already being used by several other radio broadcasters. Therefore there is a risk that the transmission will interfere with the transmissions of other radio broadcasters, or other nearby entertainment devices.

U.S. Pat. No. 6,782,239 discloses a digital audio player having an integral FM transmitter for transmitting the audio to an external FM radio or receiver. The problem of interference is minimized by the digital audio player automatically and periodically scanning a number of channels on the FM band to determine the channel having the least amount of interference. The digital audio player tunes the FM transmitter to the frequency of that channel and displays the channel to which the user should manually tune the external receiver. Later, if a better station is found for transmission, an audio or visual cue is provided to notify the user that the channel on the external radio or receiver should be changed. Again, the user must manually change the channel on the external radio or receiver.

If the radio environment is constantly changing, such as when the user is traveling in a vehicle, it may be necessary to change the channel on the external radio or receiver frequently. This can be a nuisance, particularly if the user is operating the vehicle, and/or if the channel is to be changed particularly frequently.

U.S. Pat. No. 6,163,711 discloses an apparatus for interfacing a mobile telephone with an existing audio system. The apparatus modulates the received audio from an incoming call with a preselected FM carrier frequency and broadcasts the resulting low power signal to the antenna of a receiver of the existing audio system. However, this apparatus is not able to detect and overcome interference on the selected channel.

It is therefore desirable to provide a radio broadcasting device for a portable entertainment device that overcomes the disadvantages associated with these known devices.

According to a first aspect of the invention, there is provided a radio broadcasting device for a portable entertainment device, the radio broadcasting device being adapted to transmit data at a first frequency; transmit, at the first frequency, information identifying an alternative frequency on which to transmit the data; and switch the transmission of the data to the alternative frequency.

According to another aspect of the invention, there is provided a portable entertainment device comprising a radio broadcasting device as described above.

According to another aspect of the invention, there is provided an adapter device for connection to a portable entertainment device, the adapter device comprising a radio broadcasting device as described above.

According to yet another aspect of the invention, there is provided a method of transmitting data from a portable entertainment device to a fixed or mobile radio receiver, the method comprising transmitting data from the portable entertainment device at a first frequency; transmitting, at the first frequency, information identifying an alternative frequency on which to transmit the data; and switching the transmission of the data to the alternative frequency.

According to a preferred embodiment, the invention further comprises detecting the presence of interference at the first frequency while the data is being transmitted at the first frequency; and selecting the alternative frequency for transmission in the event that the interference at the first frequency exceeds a predetermined threshold. The threshold provides the advantage that low levels of interference do not cause the radio broadcasting device to unnecessarily switch the frequency of transmission.

According to a preferred embodiment, the transmission is switched by ceasing transmission of the data at the first frequency and initiating transmission of the data at the alternative frequency.

According to an alternative embodiment, the transmission is switched by starting transmission of the data at the alternative frequency and concurrently reducing the power with which the data is transmitted at the first frequency.

Both of these embodiments have the advantage that a conventional radio receiver will retune to the alternative frequency automatically, without requiring the intervention of the user.

According to a preferred embodiment, the invention further comprises determining a list of candidate alternative frequencies by measuring the interference level at each frequency in the available frequency band.

In a further preferred embodiment, the list of candidate alternative frequencies is compiled by examining Radio Data System data. This has the advantage that information already transmitted over the radio interface is used, requiring no modification of existing radio network infrastructure to implement the invention.

According to a preferred embodiment, the information identifying the alternative frequency is transmitted in a Radio Data System portion of the transmission at the first frequency. This has the advantage that an existing radio interface protocol is used to implement the invention, requiring minimal, if any, modification to existing radio receivers.

According to a preferred embodiment, the invention further comprises transmitting information relating to the data from the portable entertainment device in a Radio Data System portion of the transmissions at the first and alternative frequencies. This also has the advantage that an existing radio interface protocol is used to implement the invention, requiring minimal, if any, modification to existing radio receivers.

In a further preferred embodiment, the information comprises ID tags or other relevant data, including one or more of a song title, album title, artist, lyrics or track length. In an RDS-based embodiment, this may be transmitted in the Radio Text field.

In a further preferred embodiment, the invention further comprises transmitting information relating to an identity of the portable entertainment device in a Radio Data System portion of the transmissions at the first and alternative frequencies.

In a further preferred embodiment, the information is displayed by a radio receiver. This means that the user of the portable entertainment device is able to see details of the current track without having to look at the portable entertainment device, thereby reducing the chance that the user could be distracted whilst driving a vehicle.

These and other aspects of the invention will be apparent from and elucidated with reference to the embodiment(s) described hereinafter.

For a better understanding of the present invention, and to show more clearly how it may be carried into effect, reference will now be made, by way of example, to the following drawings, in which:

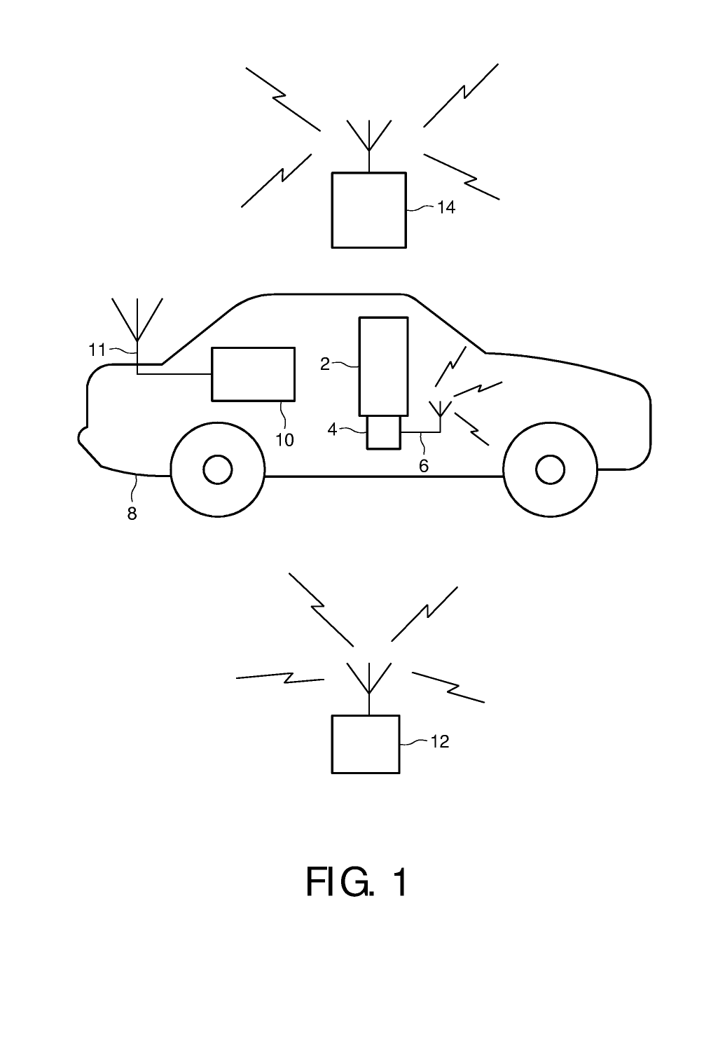

FIG. 1 shows a radio broadcasting device in accordance with one embodiment of the invention connected to a portable entertainment device;

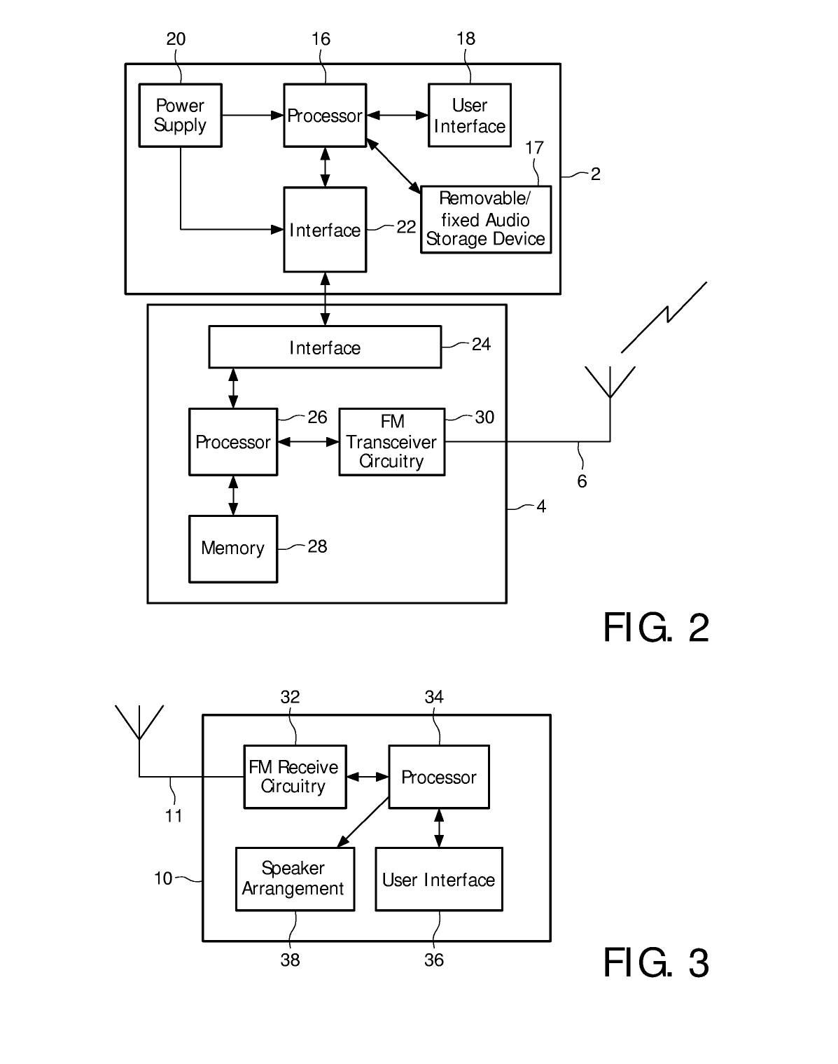

FIG. 2 is a block diagram of a radio broadcasting device according to an embodiment of the invention and a portable entertainment device;

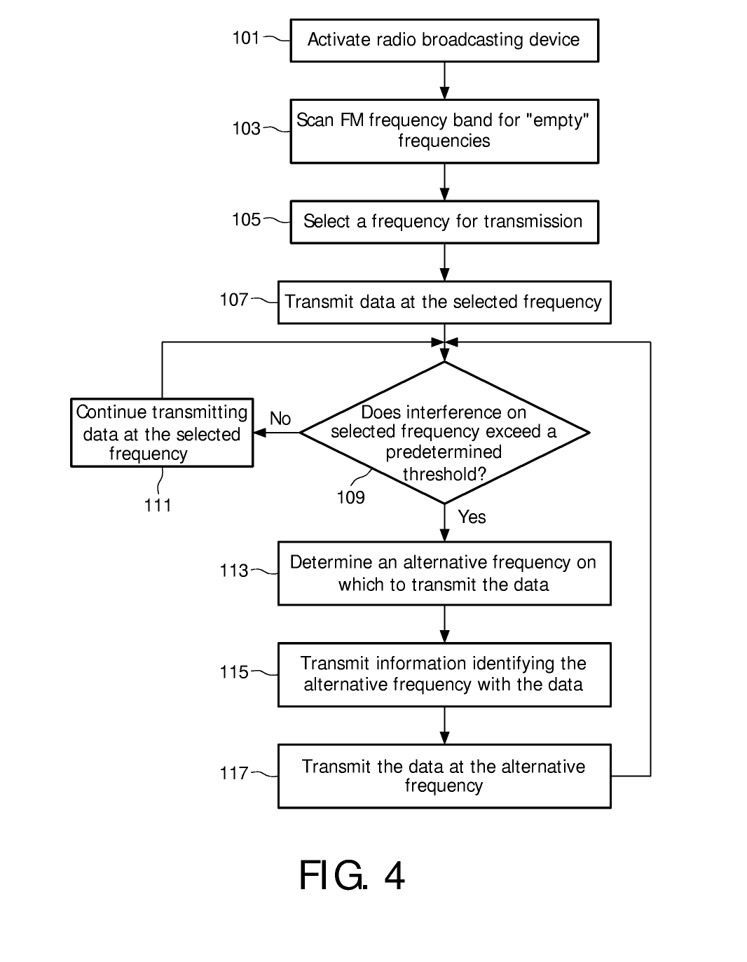

FIG. 3 is a block diagram of a conventional vehicle audio system for use with the radio broadcasting device according to the invention; and

FIG. 4 is a flow chart illustrating the steps in a method according to the invention.

FIG. 1 shows a portable entertainment device 2, which may be any device that allows music or audio stored in a digital or analogue format to be reproduced, such as a CD player, audio cassette player, mobile telephone or MP3 player, connected to a radio broadcasting device 4 in accordance with the invention.

The radio broadcasting device 4 receives an audio output from the portable entertainment device 2 and broadcasts the audio output over an air interface via antenna 6 to any neighboring radio receivers. The radio broadcasting device 4 broadcasts signals at one of a number of frequencies in a predetermined frequency band.

The radio broadcasting device 4 can be connected to the portable entertainment device 2 by any type of connection known in the art, for example a 3.5 mm headphone socket, or a USB port. In an alternative embodiment of the invention, the radio broadcasting device 4 forms an integral part of the portable entertainment device 2.

In this illustrated embodiment, the portable entertainment device 2 and radio broadcasting device 4 have been placed in a vehicle 8, which has an audio system 10 and receiving antenna or aerial 11. Although the invention will be described with reference transmitting data to a vehicle audio system, it will be readily apparent that the radio broadcasting device 4 according to the invention can be used to transmit data for reception by a neighboring fixed radio receiver, such as those found in home sound systems.

FIG. 1 also shows two other radio transmitters 12 and 14 which broadcast radio signals on respective frequencies in the predetermined frequency band. The radio transmitters 12 and 14 may belong to public radio stations or other radio broadcasting devices in the vicinity of the vehicle 8.

FIG. 2 is a block diagram of the radio broadcasting device 4 according to an embodiment of the invention connected to a portable entertainment device 2.

In the embodiment of the invention in which the radio broadcasting device 4 is separate from the portable entertainment device 2, the portable entertainment device 2 can be conventional. Thus the portable entertainment device 2 comprises a processor 16 which recreates an audio signal from data stored in or on an audio storage device 17.

The form of the audio storage device 17 depends on the nature of the portable entertainment device 2. For example, if the portable entertainment device 2 is a CD player or cassette player, the audio storage device 17 will be a removable compact disc or cassette tape respectively. Alternatively, if the portable entertainment device 2 is an MP3 player, the audio storage device 17 can be a hard disk or a fixed or removable solid-state memory device.

The portable entertainment device 2 also comprises a user interface 18 for allowing a user to operate the device 2. When the radio broadcasting device 4 is not formed integrally with the portable entertainment device 2, the operation of the portable entertainment device 2 can be conventional and will not be described further herein. When the radio broadcasting device 4 is formed integrally with the portable entertainment device 2, the user can be presented with an option to activate/deactivate the radio broadcasting device 2 as required. The user can also be presented with options relating to the frequency used for transmissions by the radio broadcasting device 4.

The portable entertainment device 2 also comprises a power supply 20, such as a battery, and an interface 22 which allows the portable entertainment device 2 to be connected to other devices or components. The interface 22 will provide at least one means for providing an audio output, such as a socket for allowing a set of headphones to be connected thereto.

In this illustrated embodiment, the radio broadcasting device 4 comprises an interface 24 for connection to the portable entertainment device 2, a processor 26 and associated memory 28 and radio transceiver circuitry 30. The radio broadcasting device 4 receives power from the power supply 20 of the portable entertainment device 2 via the interfaces 22 and 24. In an alternative embodiment, the radio broadcasting device 4 comprises a separate power supply.

The processor 26 controls the operation of the radio broadcasting device 4. In a first embodiment of the invention, when the radio broadcasting device 4 is activated, one or more candidate frequencies for transmission must be determined. The processor 26 initiates a scanning operation in which a predetermined frequency band is analyzed to determine which frequencies are currently being used by other radio broadcasters, such as local radio stations. This scanning operation involves adjusting the transceiver circuitry 30 to select each of the available frequencies in the band in turn, demodulating the signal received at each of those frequencies, and performing a measurement on the received signal. This measurement may involve determining the strength of the received signal relative to a predetermined threshold.

In accordance with one aspect of the invention, the processor 26 may use information transmitted by a radio broadcaster in a signal at a particular frequency to identify other frequencies in the band that should not be used as candidate frequencies.

If the frequency band is the band used for frequency-modulated (FM) transmissions, the radio broadcasting device 4 may use information carried in a Radio Data System (RDS) portion of the received signal to assist in identifying other frequencies in the band that are being used by particular radio broadcasters. For example, a radio broadcaster using radio transmitter 12 may broadcast on three frequencies, say, 89.1 MHz, 90.5 MHz and 92.3 MHz, and an RDS-enabled signal from the broadcaster on 89.1 MHz will include information listing the alternate frequencies (AF) 90.5 MHz and 92.3 MHz. The processor 26 can read this RDS information, and note that these other frequencies should not be listed as candidate frequencies.

Once one or more candidate frequencies for transmission have been identified, the identity of each of the candidate frequencies can be stored in the memory 28.

The processor 26 then selects one of the candidate frequencies, adjusts the transceiver circuitry 30 to the selected frequency and transmits the audio data received over the interface 24.

In an alternative embodiment of the invention, one or more default frequencies may be stored in the memory 28 of the radio broadcasting device 4. When the device 4 is activated, one of the default frequencies is selected for use in transmitting the data, rather than performing a frequency search as described above.

In a further alternative embodiment of the invention, the frequency that was last in use by the radio broadcasting device 4 before it was switched off can be stored in the memory 28. When the device 4 is activated, the last used frequency can be retrieved from the memory 28 and used to transmit the data, rather than performing a frequency search as described above.

FIG. 3 is a block diagram of a conventional vehicle audio system 10 for use with the radio broadcasting device 4 according to the invention. The vehicle audio system 10 comprises an antenna or aerial 11 that is mounted on or in the vehicle body. The aerial 11 receives signals over the air and passes them to receiver circuitry 32, which demodulates the signal received at a frequency selected by a processor 34 or by a user via user interface 36. The resulting audio output is provided to a speaker arrangement 38.

If the frequency band is the FM band and the system 10 is RDS enabled, the frequency may be selected by the processor 34 examining a RDS portion of the received signal.

It will be appreciated by a person skilled in the art that other methods of transmitting data with an audio signal may be used instead of RDS.

In accordance with the second and third embodiments of the invention described above, when the vehicle audio system 10 is switched on, the processor 34 may tune the receive circuitry 32 to the frequency that was last being used before the system 10 was switched off, or to a default frequency set by a user.

As the vehicle 8, and hence radio broadcasting device 4 moves, the radio environment will change as the vehicle 8 moves into and out of the transmission range of various other radio transmitters. This means that the transmission from the radio broadcasting device 4 may, within the area covered by the device 4, overpower any other local transmissions using the same frequency as the device 4.

Therefore, the frequency being used for transmission by the radio broadcasting device 4, which was initially determined to be a suitable frequency for transmission, must be changed.

In accordance with the invention, while the device 4 is broadcasting signals at the currently selected frequency (referred to as the “first frequency” hereinafter for clarity), the processor 26 regularly monitors the interference at that frequency to determine if it is necessary to change the transmission frequency. The processor 26 may compare the signal-to-noise ratio on the first frequency to a predetermined threshold or to the signal-to-noise ratio on each of the other frequencies available in the frequency band. Alternatively, any other measurement that is suitable for indicating interference at the first frequency may be used.

If the processor 26 determines that it is necessary to change the frequency of transmission, the processor 26 identifies a suitable alternative frequency or frequencies to be used for transmission. The identification of the alternative frequency or frequencies can be carried out in the same way the candidate frequencies are identified in the first embodiment of the invention when the radio broadcasting device 4 is activated.

In accordance with the invention, the radio broadcasting device 4 selects one of the alternative frequencies for further transmission of the audio data from the portable entertainment device 2. To initiate the switching procedure, the radio broadcasting device 4 transmits information identifying the selected alternative frequency with the current audio data being transmitted at the first frequency.

In a preferred embodiment of the invention where the frequency band is the FM band and the device 4 and receiver 10 are RDS-enabled, the information identifying the alternative frequency is transmitted in the alternative frequency (AF) portion of the RDS part of the signal.

Once this information has been transmitted by the device 4, the frequency used for transmission can be switched to the alternative frequency. The receiver 10 will use the information identifying the alternative frequency to switch its reception from the first frequency to the alternative frequency without requiring any action on the part of the user.

If the information identifying the alternative frequency was transmitted using RDS, the receiver 10 will use the automatic tuning function built into a conventional RDS receiver.

In an alternative embodiment of the invention, instead of identifying a suitable alternative frequency for transmission when the processor 26 determines that the frequency must be changed, the radio broadcasting device 4 can identify a suitable alternative frequency or frequencies to be used for transmission in advance of signal interference being detected. The identity of the suitable alternative frequency or frequencies can be stored in the memory 28. The list of alternative frequencies can be maintained and updated periodically by the processor 26.

When the processor 26 determines that the frequency of transmission must be changed, the or one of the alternative frequencies is selected for use, and the radio broadcasting device 4 transmits information identifying the selected alternative frequency with the current audio data being transmitted at the first frequency.

In a preferred embodiment of the invention where the frequency band is the FM band and the device 4 and receiver 10 are RDS-enabled, the information identifying the alternative frequency is transmitted in the alternative frequency (AF) portion of the RDS part of the signal. This has the advantage that existing RDS receivers may be used, which are particularly capable of swiftly tuning in on the alternate frequency switched to, i.e. without any audible consequences.

In an alternative embodiment, when the alternative frequency or frequencies are identified before it is determined that it is necessary to change the frequency being used for transmission, information identifying the alternative frequency or frequencies can be periodically transmitted with the current audio data being transmitted at the first frequency.

In this embodiment, as the radio broadcasting device 4 already has an alternative frequency selected, and as the receiving system has already been informed of the alternative frequency, the frequency used for transmission can be switched to the alternative frequency much quicker than in the embodiment described above, thereby reducing the chance that a user will hear interference in the audio output.

The radio broadcasting device 4 can switch its transmission to the alternative frequency in one of several ways. In a preferred embodiment, the radio broadcasting device 4 gradually reduces the power at which the signal is broadcast at the first frequency while correspondingly increasing the power at which the signal is broadcast at the alternative frequency. The receiver of system 10 will detect that the quality of the received signal at the first frequency is deteriorating and will retune to the indicated alternative frequency automatically.

Alternatively, the radio broadcasting device 4 can switch straight from transmitting at the first frequency to transmitting at the alternative frequency. The receiver of system 10 will detect that the signal at the first frequency has been lost and will retune to the alternative frequency.

In a preferred embodiment of the invention, information about the current audio track being played can also be included in the signal broadcast by the device 4. The information, which comprises ID tags or other relevant data, could include the song title, album title, artist or length of audio track can be decoded in the receiver of system 10 and displayed on a display in the user interface 36. In the embodiment of the invention in which the device 4 is RDS-enabled, this information can be transmitted in the RDS portion of the signal broadcast by the device 4.

In a further embodiment of the invention, information about the identity of the portable entertainment device 2 (e.g. “MP3 Rich”) can be transmitted by the radio broadcasting device 4 to the receiver 10. This identity allows the user of the receiver 10 to initially tune the receiver 10 to the correct frequency.

For example, when the receiver 10 and radio broadcasting device 4 are activated, the user will need to manually tune the receiver 10 to the correct channel to receive the audio signal from the portable entertainment device 2. The receiver 10 displays the identity of the station on the currently selected frequency. The user can then change the frequency of the receiver 10 until “MP3 Richdevice_ID” is displayed. The receiver will then be tuned to the correct frequency.

In the embodiment of the invention in which the device 4 is RDS-enabled, this identity can be transmitted in the RDS portion of the signal broadcast by the device 4. Particularly, the identity may be broadcasted as a Program Identifier, or in textual form as a Program Service Name.

FIG. 4 is a flowchart showing the steps in a method according a first embodiment of the invention. In step 101, the radio broadcasting device is activated and in step 103 a scanning operation is initiated in which the radio broadcasting device scans the available frequency band for unused or empty frequencies. As described above, this scanning operation can involve comparing the signal strength at each frequency relative to a threshold, and can also use alternate frequency information that might be transmitted with a signal on a particular frequency.

In step 105, one of the frequencies found in step 103 is selected as the frequency to be used for transmission. In step 107, audio data from the portable entertainment device is transmitted at the selected frequency. As mentioned above, in a preferred embodiment of the invention, the transmission may also include information about the audio data that can be decoded in a receiver and displayed for a user.

In step 109, it is determined whether the level of interference at the selected frequency exceeds a predetermined threshold. If the level of interference is below the threshold, the device continues to broadcast the data at the selected frequency (step 111).

However, if the level of interference is above the threshold, it is necessary to determine an alternative frequency at which to transmit the data from the portable entertainment device (step 113). This determination can be similar to the scanning operation performed in step 103 above.

Once an alternative frequency has been determined, information identifying the alternative frequency is transmitted with the audio data (step 115).

In step 117, the device switches the transmission frequency to the alternative frequency. As described above, the device may gradually decrease the transmission power of the signal at the first frequency whilst gradually increasing the transmission power of the signal at the alternative frequency. The receiver in the vehicle audio system will detect the change in the signal strength of the transmission and use the alternative frequency data in the signal to automatically retune to the alternative frequency.

Once the device has started transmitting at the alternative frequency, the process returns to step 109 where the interference levels are monitored until it is determined that it is necessary to change the transmission frequency again.

There is therefore described a radio broadcasting device that overcomes the problems caused by interference in a rapidly changing radio environment, and which uses technology available in a conventional vehicle audio system to retune the receiver without requiring any action on the part of the user of the vehicle.

It will be appreciated that the term “comprising”, as used herein, does not exclude other elements or steps, that “a” or “an” does not exclude a plurality, and that a single processor or other unit may fulfill the functions of several means recited in the claims.

Although the invention has been described herein as being for use with a portable entertainment device, it will be appreciated that the invention can also be used with fixed entertainment devices in which data is to be transmitted from the entertainment device for reception by a neighboring fixed or portable radio receiver, such as those found in home sound systems.

1-14. (canceled)

15. A radio broadcasting device for transmitting data from a portable entertainment device, the radio broadcasting device being adapted to:
transmit data at a first frequency;
transmit, at the first frequency, information identifying an alternative frequency on which to transmit the data; and
switch the transmission of the data to the alternative frequency
wherein the radio broadcasting device is adapted to switch the transmission of the data to the alternative frequency by starting transmission of the data at the alternative frequency and concurrently reducing the power with which the data is transmitted at the first frequency.

16. A radio broadcasting device as claimed in claim 15 that is further adapted to:
detect the presence of interference at the first frequency while the data is being transmitted at the first frequency; and
select the alternative frequency for transmission in the event that the interference at the first frequency exceeds a predetermined threshold.

17. A radio broadcasting device as claimed in claim 15, wherein the radio broadcasting device is adapted to switch the transmission by ceasing transmission of the data at the first frequency and initiating transmission of the data at the alternative frequency.

18. A radio broadcasting device as claimed in claim 15, wherein the radio broadcasting device is further adapted to determine a list of candidate alternative frequencies by measuring the interference level at each frequency in the available frequency band.

19. A radio broadcasting device as claimed in claim 18, wherein the radio broadcasting device is adapted to compile the list of candidate alternative frequencies by examining Radio Data System data.

20. A radio broadcasting device as claimed in claim 15, wherein the radio broadcasting device is adapted to transmit the information identifying the alternative frequency in a Radio Data System portion of the transmission at the first frequency.

21. A radio broadcasting device as claimed in claim 15, wherein the radio broadcasting device is further adapted to transmit information relating to the data from the portable entertainment device in a Radio Data System portion of the transmissions at the first and alternative frequencies.

22. A radio broadcasting device as claimed in claim 21, wherein the information comprises ID tags or other relevant data, including one or more of a song title, album title, artist or track length.

23. A radio broadcasting device as claimed in claim 15, wherein the device is further adapted to transmit information relating to an identity of the portable entertainment device in a Radio Data System portion of the transmissions at the first and alternative frequencies.

24. A radio broadcasting device as claimed in claim 21, wherein the information is for display by a radio receiver.

25. A portable entertainment device comprising a radio broadcasting device as claimed in claim 15.

26. An adapter device for connection to a portable entertainment device, the adapter device comprising a radio broadcasting device as claimed in claim 15.

27. A method of transmitting data from a portable entertainment device to a fixed or mobile radio receiver, the method comprising:
transmitting data from the portable entertainment device at a first frequency;
transmitting, at the first frequency, information identifying an alternative frequency on which to transmit the data; and
switching the transmission of the data to the alternative frequency by starting transmission of the data at the alternative frequency and concurrently reducing the power with which the data is transmitted at the first frequency.
